(19) United States
(12) Patent Application Publication
(10) Pub. No.: US 2013/0325199 A1
(43) Pub. Date: Dec. 5, 2013

(54) SATELLITE SIGNAL-BASED UTILITY GRID CONTROL

(71) Applicant: Peter W. Coe, Wiltshire (GB)

(72) Inventor: Peter W. Coe, Wiltshire (GB)

(21) Appl. No.: 13/995,064

(22) PCT Filed: Dec. 27, 2011
(86) PCT No.: PCT/US11/67402

§ 371 Date: Jun. 17, 2013

(51) Int. Cl. G06Q 50/06

(52) U.S. Cl. CPC G06Q 50/06
USPC 700/291

(57) ABSTRACT

Satellite signal-based control and management of utility grids is provided. Satellite signal measurements at one or more remote receiver devices may be utilized, for example, to determine an actual or estimated amount of cloud disruption in a given area. The cloud disruption data may then be utilized, in some embodiments, to predict solar generation output and/or grid demand levels, and/or modify electrical grid settings to accommodate for such solar generation levels.

### BACKGROUND OF THE INVENTION

Power distribution infrastructure for residential, commercial, and industrial customers has traditionally been energized by large, centralized power generation facilities. Increasingly, such infrastructure (i.e., the “electric grid” or “grid”) has been supplemented by various forms of distributed energy generation facilities such as gas turbines, diesel generators, and renewable technologies such as wind and solar.

It is necessary to manage the electrical supply through the grid, from both centralized and distributed generation sources, to meet electrical usage demand. This task is complicated, however, by the fact that not all distributed generation facilities are capable of on-demand or constant supply levels. In the case of wind and solar power, for example, the output of such facilities is highly (if not entirely) dependent upon the prevailing weather.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a diagram of an example graph according to some embodiments;

FIG. 4 is perspective diagram of a system according to some embodiments;

FIG. 5 is a diagram of an example graph according to some embodiments;

FIG. 6 is flow diagram of a method according to some embodiments;

FIG. 7 is a block diagram of an apparatus according to some embodiments; and

FIG. 8A and FIG. 8B are perspective diagrams of example data storage devices according to some embodiments.

### DETAILED DESCRIPTION OF EXAMPLE EMBODIMENTS

Embodiments described herein are descriptive of systems, apparatus, methods, and articles of manufacture for utilizing satellite signal data to determine (or infer) renewable energy supply. Some embodiments comprise, for example, receiving (e.g., by a central controller device and/or from a remote satellite signal receiver device) information descriptive of a signal strength of a satellite signal sent to a remote satellite signal receiver device, determining (e.g., by the central controller device and/or based on the information) an estimated magnitude of cloud disruption in an area associated with the remote satellite signal receiver device, and providing (e.g., by the central controller device and/or based on the estimated magnitude of cloud disruption in the area associated with the remote satellite signal receiver device) an indication of an estimated amount of electrical grid power demand.

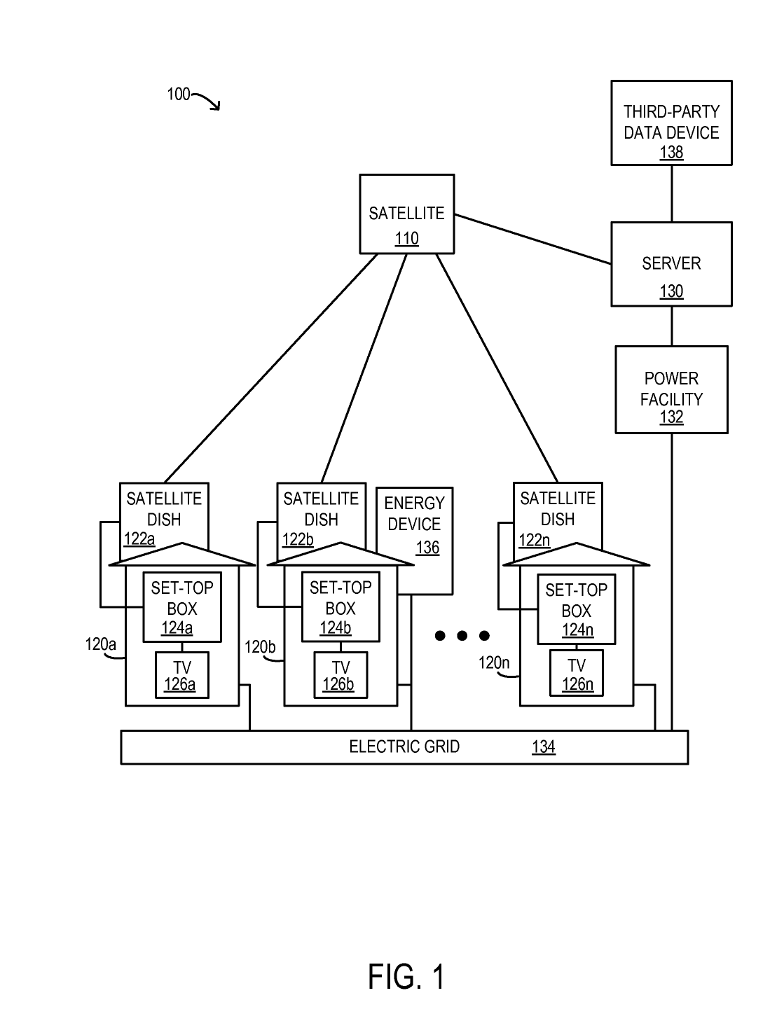

Referring first to FIG. 1, a block diagram of a system 100 according to some embodiments is shown. In some embodiments, the system 100 may comprise a satellite 110 and/or a plurality of buildings 120a-n. According to some embodiments, the buildings 120a-n may comprise satellite dishes 122a-n, set-top boxes 124a-n, and/or TV devices 126a-n. As is typical for satellite-based entertainment and/or internet access, for example, the satellite 110 (e.g., in a geo-stationary orbit, typically somewhere over the equatorial region of the earth) may provide and/or transmit a signal to any or all of the satellite dishes 122a-n (which may, for example, be appropriately aligned and/or configured to receive such a signal). The signal may be relayed and/or provided to the set-top boxes 124a-n which may, for example, decode, decrypt, decompress, format, and/or otherwise process or manage the data from the satellite signal prior to providing and/or sending the processed data to the TV devices 126a-n. The TV devices 126a-n are depicted for ease of illustration and explanation. In some embodiments, any or all of the TV devices 126a-n may also or alternatively comprise other user devices, network devices, and/or output devices such as computer output devices, tablet output devices, cellular telephone and/or smart-phone output devices, satellite and/or internet radio output devices, Voice-over-Internet-Protocol (VoIP) output devices, etc. Similarly, the set-top boxes 124a-n may also or alternatively comprise any configuration of signal receiving devices, routers, modems, and/or signal and/or data processing devices that are or become practicable and/or desirable.

In some embodiments, the set-top boxes 124a-n (and/or the satellite dishes 122a-n or components thereof) may comprise Automatic Gain Control (AGC) functionality. In other words, the set-top boxes 124a-n (and/or the satellite dishes 122a-n or components thereof) may comprise circuitry operable to alter or adjust a signal output level based on a level or strength of an input signal. For example, a weak signal from the satellite 110 may be amplified and/or a strong signal from the satellite 110 may be reduced. In such a manner, the set-top boxes 124a-n (and/or the satellite dishes 122a-n or components thereof) are responsive to different levels, magnitudes, and/or strengths of signals received from the satellite 110.

According to some embodiments, information descriptive of the different levels, magnitudes, and/or strengths of signals received (e.g., by the set-top boxes 124a-n (and/or the satellite dishes 122a-n or components thereof)) from the satellite 110 may be provided to a server 130. In some embodiments, the information may be transmitted back from the set-top boxes 124a-n (and/or the satellite dishes 122a-n or components thereof) to the satellite 110 and relayed or provided by the satellite 110 to the server 130. For example, AGC settings from the set-top boxes 124a-n (and/or the satellite dishes 122a-n or components thereof) may be sent back to the satellite 110 and transmitted from the satellite 110 to the server 130. In some embodiments, the information (such as AGC data) may be provided other than via the satellite 110. The set-top boxes 124a-n (and/or the satellite dishes 122a-n or components thereof) may, for example, communicate with the server 130 via one or more other networks (not explicitly shown in FIG. 1) such as the Internet and/or a cellular telephone or a Public Switched Telephone Network (PSTN).

In some embodiments, the server 130 may be in communication with a power facility device 132, an electric grid 134, and/or an energy device 136. The server 130 may, for example, comprise a computing device and/or central controller configured and/or coupled to manage the electric grid 134, the power facility 132, and/or the energy device 136. In some embodiments, the server 130 may be owned and/or operated by a utility company and/or governmental body (e.g., a utility regulation and/or control entity). The server 130 may, for example, manage generation, flow, and/or other characteristics of electrical energy within the electric grid 134 such as by causing the power facility 132 and/or the energy device 136 to operate in desired manners. In some embodiments, the system 100 may comprise and the server 130 may be in communication with a third-party device 138. The third-party device 138 may, for example, provide data to the server 130 that the server 130 utilizes to inform how and/or when actions with respect to the electric grid 134, the power facility 132, and/or the energy device 136 should be effectuated.

According to some embodiments, the server 130 may comprise an electronic and/or computerized controller device such as a computer server communicatively coupled to interface with the satellite 110, the power facility 132, the electric grid 134, and/or the energy device 136 (directly and/or indirectly). The server 130 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the server 130 may be located remotely from one or more of the buildings 120a-n, the power facility 132, the third-party device 138, and/or the satellite 110. The server 130 may also or alternatively comprise a plurality of electronic processing devices located at one or more various sites and/or locations.

In some embodiments, the server 130 may store and/or execute specially programmed instructions to operate in accordance with embodiments described herein. The server 130 may, for example, execute one or more programs that manage and/or control the electric grid 134, the power facility 132, and/or the energy device 136 based on information descriptive of satellite signal levels, magnitudes, and/or strengths received by the set-top boxes 124a-n (and/or the satellite dishes 122a-n and/or components thereof). According to some embodiments, the server 130 may comprise a computerized processing device such as a Personal Computer (PC), laptop computer, computer server, and/or other electronic device configured and/or coupled to manage and/or facilitate electric current flow and/or distribution (e.g., via the electric grid 134) based on satellite signal level data (e.g., AGC data from the set-top boxes 124a-n). The server 130 may be utilized, for example, to (i) receive an indication of satellite signal strength, (ii) determine (based on the satellite signal strength) an estimated magnitude of cloud disruption, (iii) determine and/or provide (based on the estimated magnitude of cloud disruption) an estimated amount of electrical grid power demand, and/or (iv) cause one or more of the electric grid 134, the power facility 132, and/or the energy device 136 to operate in response to the estimated amount of electrical grid power demand (e.g., in accordance with embodiments described herein).

According to some embodiments, the power facility device 132 may comprise any type, quantity, and/or configuration of device(s) that is operable and/or coupled to generate, direct, process, and/or otherwise manage electrical power. The power facility device 132 may comprise (but is not limited to), for example, a power generation facility such as a coal, natural gas, hydropower, biomass, and/or nuclear power generation facility, an electrical switching device, distribution device, and/or transforming device, and/or an electric metering device. In some embodiments, although depicted separately in FIG. 1, the power facility device 132 may be part of the electric grid 134. The electric grid 134 may, for example, comprise a plurality of electric power facilities 132. In some embodiments, the electric grid 134 may be coupled to provide power to the buildings 120a-n and/or the electrical components 122a-n, 124a-n, 126a-n therein. In some embodiments, the electric grid 134 may be coupled to provide power to and/or receive power from the energy device 136.

In the case that the energy device 136 comprises a distributed generation facility or device (such as a photovoltaic array and/or associated components), for example, the energy device 136 may provide power to the electric grid 134. In some embodiments, such as in the case that the energy device 136 comprises a solar electric generation device, the satellite signal strength information obtained by the server 130 may be utilized to determine and/or estimate how much electrical energy the energy device 136 is likely to provide to the electric grid 134 (e.g., at a specific point in time and/or over a particular time period). In such embodiments, the server 130 may cause the power facility 132 to increase or decrease power generation and/or switch, transfer, or direct power to specific portions of the electric grid 134, based upon how much energy is expected from the energy device 136. On a larger scale, such as in the case that the energy device 136 comprises a plurality of distributed electric generation devices, the embodiments herein may be utilized to facilitate the ability of the electric grid 134 to meet demand based on fluctuating electric supply from renewable sources (e.g., by estimating output based on cloud disruption levels derived from satellite signal data).

In some embodiments, the third-party device 138 may comprise any type or configuration of computerized processing device such as a PC, laptop computer, computer server, database system, and/or other electronic device, devices, or any combination thereof. In some embodiments, the third-party device 138 may be owned and/or operated by a third-party (i.e., an entity different than any entity owning and/or operating the server 130; not explicitly shown in FIG. 1). The third-party device 138 may, for example, be owned and/or operated by a data service provider. In some embodiments, the third-party device 138 may supply and/or provide data such as weather data, consumer and/or demographic data, electrical demand data, public records, and/or other metrics to the server 130. In some embodiments, the third-party device 138 may comprise a plurality of devices (e.g., may comprise a plurality of data devices) and/or may be associated with a plurality of third-party entities (not shown in FIG. 1).

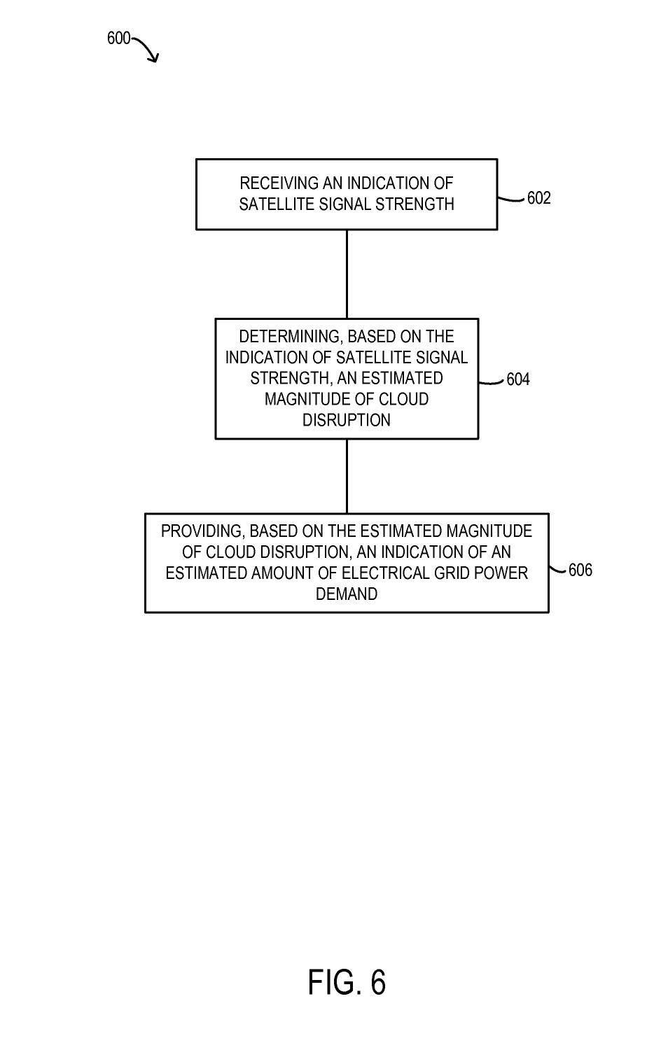

Fewer or more components 110, 120a-n, 122a-n, 124a-n, 126a-n, 130, 132, 134, 136, 138 and/or various configurations of the depicted components 110, 120a-n, 122a-n, 124a-n, 126a-n, 130, 132, 134, 136, 138 may be included in the system 100 without deviating from the scope of embodiments described herein. In some embodiments, the components 110, 120a-n, 122a-n, 124a-n, 126a-n, 130, 132, 134, 136, 138 may be similar in configuration and/or functionality to similarly named and/or numbered components as described herein. In some embodiments, the system 100 (and/or portion thereof, such as the server 130) may be programmed to and/or may otherwise be configured to execute, conduct, and/or facilitate the method 600 of FIG. 6 and/or portions or combinations thereof described herein.

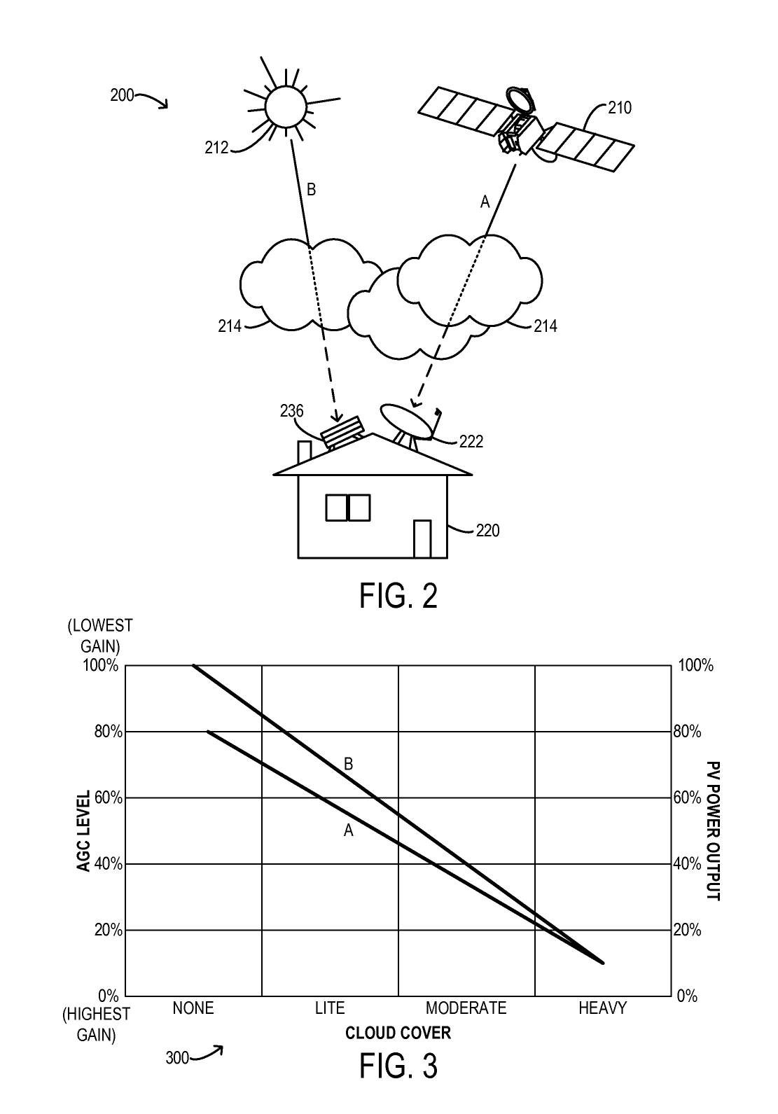

Turning now to FIG. 2, a block diagram of a system 200 according to some embodiments is shown. In some embodiments, the system 200 may conduct and/or facilitate management of an electric grid based on satellite signal strength measurements. The system 200 may, for example, be similar in configuration and/or functionality to the system 100 of FIG. 1 herein. According to some embodiments, the system 200 may comprise a satellite 210, the sun 212, and/or one or more clouds 214 (or cloud cover). In some embodiments, the system 200 may comprise a house 220 comprising a satellite signal receiver 222 and/or a solar power array 236.

According to some embodiments, the satellite 210 may send a signal “A” (such as a broadcast satellite signal) to the satellite signal receiver 222 (which may comprise a satellite dish, a signal meter, a receiver and/or decoder, and/or a Low-Noise Block (LNB) downconverter, e.g., none of which are explicitly labeled and/or shown in FIG. 2). As depicted in FIG. 2, the signal “A” may pass through the clouds 214 before being received by the satellite signal receiver 222. In some embodiments, as the signal “A” passes through the clouds 214, it is affected, such as by loosing strength and/or being distorted. As described with respect to the system 100 of FIG. 1, in the case that the satellite signal receiver 222 is equipped with AGC functionality, such signal strength and/or distortions may be attenuated by the satellite signal receiver 222 (e.g., by varying levels of application and/or activation of the AGC functionality).

In some embodiments, light “B” from the sun 212 may also pass through the clouds 214 prior to being received by the solar power array 236. The light “B” may also degrade in strength, temperature, and/or otherwise be distorted prior to reaching the solar power array 236. As the solar power array 236 may generally be configured to utilize solar energy from the light “B” to produce electrical energy (directly and/or by capturing thermal energy there from), the electrical output of the solar power array 236 may vary depending upon the magnitude of the clouds 214 (e.g., thickness of cloud layer, altitude of the clouds 214, density of the clouds 214, etc.).

According to some embodiments, a relationship between the disruption of the satellite signal “A” due to the clouds 214 and the disruption of the light “B” due to the clouds 214 may be determined. The relationship may be utilized, for example, to estimate output of the solar power array 236 based on the AGC level (or other measure of the satellite signal “A” as experienced by the satellite signal receiver 222) of the satellite signal receiver 222. In some embodiments, the estimated output may be utilized to facilitate and/or conduct utility grid management such as determining desirable levels of electrical output from other power generation facilities and/or determining desired electrical grid switching and/or load balancing settings or actions.

Fewer or more components 210, 212, 214, 220, 222, 236 and/or various configurations of the depicted components 210, 212, 214, 220, 222, 236 may be included in the system 200 without deviating from the scope of embodiments described herein. In some embodiments, the components 210, 212, 214, 220, 222, 236 may be similar in configuration and/or functionality to similarly named and/or numbered components as described herein. In some embodiments, the system 200 (and/or a portion thereof and/or a component in communication therewith, such as the server 130 of FIG. 1, not shown in FIG. 2) may be programmed to and/or may otherwise be configured to execute, conduct, and/or facilitate the method 600 of FIG. 6 and/or portions or combinations thereof described herein.

Referring to FIG. 3, a diagram of an example graph 300 according to some embodiments is shown. The example graph 300 depicts an exemplary correlation between cloud cover, AGC level, and Photo-Voltaic (PV) power output. The x-axis shows levels of cloud cover (with qualitative measure) from lowest to highest, the primary y-axis shows AGC level (as a percentage of maximum gain setting) from lowest to highest, and the secondary y-axis shows PV power output (as a percentage of total possible) from lowest to highest. As depicted in FIG. 3, a first inverse relationship “A” may exist, in some embodiments, between cloud cover levels (disruption levels) and AGC levels. In some embodiments, a second inverse relationship “B” may exist between cloud cover levels (disruption levels) and PV output levels. As described in relation to the system 200 of FIG. 2, such relationships (“A”, “B”) may be utilized to determine a correspondence (or third relationship, not explicitly depicted graphically in FIG. 3) between AGC levels and PV output. In such a manner, for example, monitoring and/or analysis of AGC levels may be utilized to predict (and/or measure or monitor) PV (and/or other solar or weather-dependent power generation) contribution to an electrical grid. Once the expected (or actual) PV contribution to the electrical grid is determined, the grid may be managed to meet electric demand (e.g., in a proactive fashion—thus likely reducing the occurrence of and/or preventing electric service disruptions due to inadequate power supply to the grid). In the example of FIG. 3, for instance, as AGC readings are determined to decrease, a corresponding decrease in expected or actual PV output may be inferred. In some embodiments, such a decrease in expected or actual PV output may be utilized to increase non-PV power production and/or to switch or transfer power from one portion of an electric grid to another (e.g., divert energy to the area where PV output is lower).

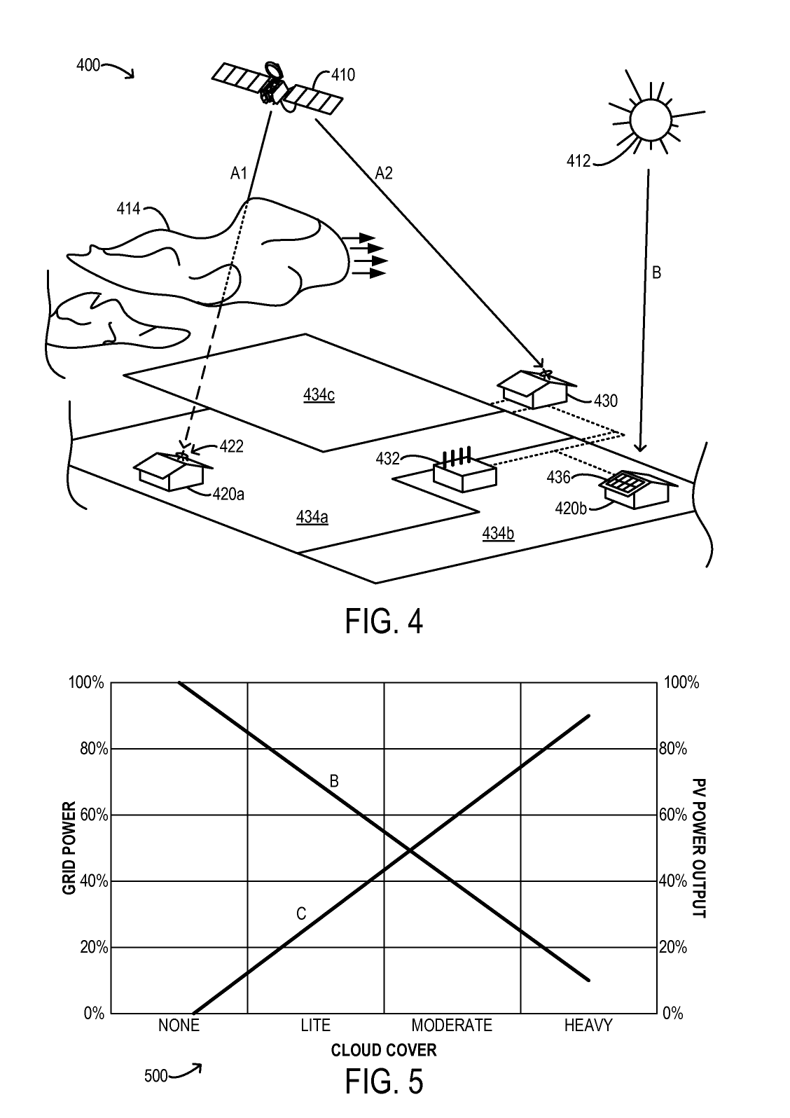

Referring now to FIG. 4, a perspective diagram of a system 400 according to some embodiments is shown. In some embodiments, the system 400 may conduct and/or facilitate management of an electric grid based on satellite signal strength measurements. The system 400 may, for example, be similar in configuration and/or functionality to the systems 100, 200 of FIG. 1 and/or FIG. 2 herein. According to some embodiments, the system 400 may comprise a satellite 410, the sun 412, and/or one or more clouds 414 (or cloud cover). In some embodiments, the system 400 may comprise a first house 420a and/or a second house 420b. The first house 420a may comprise, for example, a satellite signal receiver 422 (e.g., configured to receive a first signal “A1” from the satellite 410). According to some embodiments, the system 400 may comprise a central office 430 electrically coupled to a power facility 432 and a plurality of electrical distribution grids 434a-c. In some embodiments, the central office 430 may be configured and/or coupled to receive a second signal “A2” from the satellite 410). In some embodiments, the second house 420b may comprise a solar power device 436 configured to receive energy “B” from the sun 412 (e.g., to generate thermal and/or electrical energy).

According to some embodiments, the satellite 410 may send the first signal “A1” (such as a broadcast satellite signal) to the satellite signal receiver 422 (which may comprise a satellite dish, a signal meter, a receiver and/or decoder, and/or a Low-Noise Block (LNB) downconverter, e.g., none of which are explicitly labeled and/or shown in FIG. 4). As depicted in FIG. 4, the first signal “A1” may pass through the clouds 414 before being received by the satellite signal receiver 422. In some embodiments, as the first signal “A1” passes through the clouds 414, it is affected, such as by loosing strength and/or being distorted. As described with respect to the systems 100, 200 of FIG. 1 and/or FIG. 2 herein, in the case that the satellite signal receiver 422 is equipped with AGC (and/or other satellite signal strength detection) functionality, such signal strength and/or distortions may be attenuated by the satellite signal receiver 422 (e.g., by varying levels of application and/or activation of the AGC functionality). According to some embodiments, data descriptive of the AGC and/or other measurement(s) of the strength of the first signal “A1” may be provided to and/or transmitted back to the satellite 410 (and/or directly to the central office 430, such transmission path not shown explicitly in FIG. 4). In some embodiments, the AGC and/or other satellite signal strength data may be provided to the central office 430 (such as via the second satellite signal “A2”). While the first satellite signal “A1” and the second satellite signal “A2” are depicted separately in FIG. 4, data may provided by the satellite in a broadcast and/or single-stream transmission and various receiving devices may be operable to decode and/or process different portions of the transmission. The first house 420a may ultimately receive and utilize entertainment programming from a combined first and second signal “A1”+“A2”, for example, while the central office 430 may only utilize AGC data provided by the combined first and second signal “A1”+“A2”.

In some embodiments, the energy “B” from the sun 412 may be unobstructed and/or unaffected by the clouds 414 prior to being received by the solar power device 436. Accordingly, the solar power device 436 may provide a predictable, steady, and/or maximum amount of power to the second electrical distribution grid 434b to which it is coupled (and/or in which it is situated). Based on the AGC data that the central office 430 receives (e.g., from the satellite 410 and/or from the first house 420a), however, it may be determined that the solar power device 436 is likely to experience a disruption (e.g., of a certain magnitude based on AGC data), and that the second electrical distribution grid 434b is thus likely to experience a shortfall in supply. Based on the AGC data and/or third-party data (such as from a third-party weather service), for example, it may be determined that the clouds 414 are moving toward the second house 420b (and, accordingly, the solar power device 436). In some embodiments, the AGC levels over time may be analyzed to determine whether the clouds 414 are increasing or decreasing in disruption levels (e.g., to predict a likely effect of the clouds 414 on the solar power device 436 upon arrival of the clouds 414 in the area of the second house 420b). Other third-party data may be utilized, such as angle of the sun 412 (and/or angle of the path of the energy “B”), electrical grid demand data, and/or geographic information (e.g., locations and/or terrain) to determine when, how, and/or for how long the clouds 414 are likely to impact the solar power device 436 (and/or to determine how much total electrical energy will likely be required at the time of the disruption).

According to some embodiments, a relationship between the disruption of the first satellite signal “A1” due to the clouds 414 and the likely disruption of the energy “B” due to the clouds 414 may be determined The relationship may be utilized, for example, to estimate output of the solar power device 436 based on the AGC level (or other measure of the first satellite signal “A1” as experienced by the satellite signal receiver 422) of the satellite signal receiver 422. In some embodiments, the estimated output may be utilized to facilitate and/or conduct utility grid management such as determining desirable levels of electrical output from the power facility 432 and/or determining desired electrical grid switching and/or load balancing settings or actions.

In some embodiments for example, the central office 430 (and/or one or more devices thereof, not explicitly shown in FIG. 4), after receiving the AGC data, may determine that the solar power device 436 is likely, at some determined time (and/or for some determined duration), to experience an electrical output disruption. To counteract this disruption, the central office 430 (and/or one or more devices thereof) may determine an amount of electrical energy required from the power facility 432 (e.g., in the case that the power facility 432 comprises an electrical generation facility). The central office 430 (and/or one or more devices thereof) may accordingly instruct and/or cause the power facility 432 to produce an amount of power necessary to make up for any likely deficiency of the solar power device 436 (e.g., at a time based on the expected timing of the disruption event). In some embodiments, such as in the case that the central office 430 (and/or one or more devices thereof) is coupled to multiple electrical distribution grids 434a-c (e.g., sub-grids or circuits), the details of the expected disruption may be utilized to shift, switch, and/or transfer power from one electrical distribution grid 434a-c to another. In the case of an expected shortfall of output from the solar power device 436, for example, the central office 430 (and/or one or more devices thereof) may cause power to be supplied to the second electrical distribution grid 434b from one or more of the other adjacent and/or connected electrical distribution grids 434a, 434c, such as a magnitude of power sufficient to compensate for the expected shortfall.

Fewer or more components 410, 412, 414, 420a-b, 422, 430, 432, 434a-c, 436 and/or various configurations of the depicted components 410, 412, 414, 420a-b, 422, 430, 432, 434a-c, 436 may be included in the system 400 without deviating from the scope of embodiments described herein. In some embodiments, the components 410, 412, 414, 420a-b, 422, 430, 432, 434a-c, 436 may be similar in configuration and/or functionality to similarly named and/or numbered components as described herein. In some embodiments, the system 400 (and/or a portion thereof) may be programmed to and/or may otherwise be configured to execute, conduct, and/or facilitate the method 600 of FIG. 6 and/or portions or combinations thereof described herein.

Referring to FIG. 5, a diagram of an example graph 500 according to some embodiments is shown. The example graph 500 depicts an exemplary correlation between cloud cover, PV power output, and electric grid power output level (minus the PV power output). The x-axis shows levels of cloud cover (with qualitative measure) from lowest to highest, the primary y-axis shows electrical grid power levels (as a percentage of maximum or total capacity) from lowest to highest, and the secondary y-axis shows PV power output (as a percentage of total possible) from lowest to highest. As depicted in FIG. 5, an inverse relationship “B” may exist, in some embodiments, between cloud cover levels (disruption levels) and PV power output levels. In some embodiments, a direct relationship “C” may exist between cloud cover levels (disruption levels) and electrical grid power levels (which may also be described as an inverse relationship between PV power output levels and electrical grid power levels—e.g., the more power from PV that is supplied to the grid, the lower the power requirements from other sources may be). As described in relation to the systems 200, 400 of FIG. 2 and/or FIG. 4 herein, such relationships “B” and “C” may be utilized to determine a correspondence (or third relationship, not explicitly depicted graphically in FIG. 5) between PV output and required electrical grid power levels. In such a manner, for example, monitoring and/or analysis of PV power levels (e.g., via AGC and/or other satellite signal-based measurements) may be utilized to predict PV (and/or other solar or weather-dependent power generation) contribution to an electrical grid.

Once the expected (or actual) PV contribution to the electrical grid is determined, the grid may be managed to meet electric demand (e.g., in a proactive fashion—thus likely reducing the occurrence of and/or preventing electric service disruptions due to inadequate power supply to the grid). In the example of FIG. 5, for instance, as PV output (e.g., to the electrical grid) is expected to decrease, a corresponding increase in non-PV power production and/or a switch or transfer of power from one portion of an electric grid to another (e.g., to divert energy to the area where PV output is lower) may be implemented. In other words, if PV power output is expected to drop twenty percent (20%), then other electrical production and/or sources may be activated to compensate for the expected decrease in available power. In some embodiments, the response or action taken in light of an expected magnitude and/or duration of PV disruption may also take into account expected demand levels at or during the time of the disruption (if demand is expected to fall twenty percent (20%) by the time the disruption is expected to occur, for example, then no action may be required to counteract the loss of available grid power due to the disruption.

Turning to FIG. 6, a flow diagram of a method 600 according to some embodiments is shown. In some embodiments, the method 600 may be performed and/or implemented by and/or otherwise associated with one or more specialized and/or computerized processing devices, specialized computers, computer terminals, computer servers, computer systems and/or networks, and/or any combinations thereof (e.g., the server 130 and/or the set-top boxes 124a-n of FIG. 1 and/or the central office 430 of FIG. 4). In some embodiments, the method 600 may be embodied in, facilitated by, and/or otherwise associated with various input mechanisms and/or interfaces. In some embodiments, the components 602, 604, 606 of the method 600 may be similar in configuration and/or functionality to similarly named and/or numbered components as described herein.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 600 may be illustrative of a process implemented to manage utility grid activities and/or settings based on estimations (and/or derived current values) of power availability to the grid, such as based on satellite signal data as described herein. According to some embodiments, the method 600 may comprise receiving an indication of satellite signal strength, at 602. The indication of satellite signal strength may, for example, be received from one or more set-top boxes, signal strength meters, satellite dishes and/or components, game consoles, modems, routers, satellites, and/or other devices capable of and/or configured to measure and/or provide indications of satellite signal strength. As described herein, in some embodiments AGC levels and/or settings of a device may be utilized to infer and/or otherwise determine satellite signal strength (relative, qualitative, and/or quantitative). In some embodiments, indications from a plurality of remote and/or distributed devices may be received. In the case that satellite entertainment and/or service provider customers are utilized on a large scale to provide such indications, a very detailed set of data descriptive of satellite signal strengths across one or more areas and/or regions may be determined.

According to some embodiments, the method 600 may comprise determining (e.g., based on the indication of satellite signal strength) an estimated magnitude of cloud disruption, at 604. In the case that a relationship between satellite signal strength and cloud disruption and/or cloud cover characteristics is known and/or determined, for example, the satellite signal data may be utilized to calculate, lookup, infer, estimate, and/or otherwise determine a level or magnitude of cloud disruption. While clouds are utilized for ease of illustration and description herein, other forms of atmospheric and/or other satellite signal-based indicators of disruption may be utilized in accordance with some embodiments.

In some embodiments, the method 600 may comprise providing (e.g., based on the estimated magnitude of cloud disruption) an indication of an estimated amount of electrical grid power demand, at 606. In the case that the method 600 is performed and/or conducted by or on behalf of a third-party and/or service provider, for example, the data (or indications thereof) regarding cloud disruption levels and/or magnitudes may be provided, such as to a utility and/or government agency or body. The cloud disruption data may then be utilized, in some embodiments, by the receiving entity to determine how to manage electrical grid activities and/or settings. According to some embodiments, the cloud disruption data may be utilized to determine, lookup, and/or calculate the estimated amount of electrical grid power demand. A server and/or other computing device may, for example, utilize the cloud disruption data and data descriptive of a known or determined relationship between cloud disruption levels and power demand to determine the estimated amount of electrical grid power demand.

According to some embodiments, the estimated amount of electrical grid power demand may be descriptive and/or indicative of various metrics associated with electrical grid power demand. The estimated amount of electrical grid power demand may, for example, comprise an amount of consumer demand expected, an amount of expected electrical supply (such as PV supply), and/or an amount of expected power generation (e.g., from one or more facilities and/or from one or more types of generation facilities).

In some embodiments, the providing and/or determining of the estimated amount of electrical grid power demand may comprise determining, for a given area or region, an amount of PV (and/or other renewable and/or weather-dependent power source) capacity—e.g., a total, maximum, and/or typical (e.g., average) amount of power from PV grid inputs. The cloud disruption data (and/or the satellite signal data) may then be utilized, for example, to estimate and/or determine a magnitude of disruption to the available PV supply. As described herein, the timing and/or length of the disruption may also be determined. According to some embodiments, the disruption data may be utilized to determine how (and/or when) an electrical grid and/or various components thereof (e.g., in or associate with the given area or region) should be managed. Additional power generation capacity may be brought online (e.g., activated to provide input to the grid) to compensate for reduced power availability from PV sources, for example, or power may be shifted or load balanced to compensate for areas of higher or lower power supply, as desired for effective utility grid management. In some embodiments, the given area or region may comprise an area in which the data regarding satellite signal strength originates (e.g., where one or more set-top boxes and/or other reporting devices are located) and/or may comprise other areas such as adjacent and/or downwind areas.

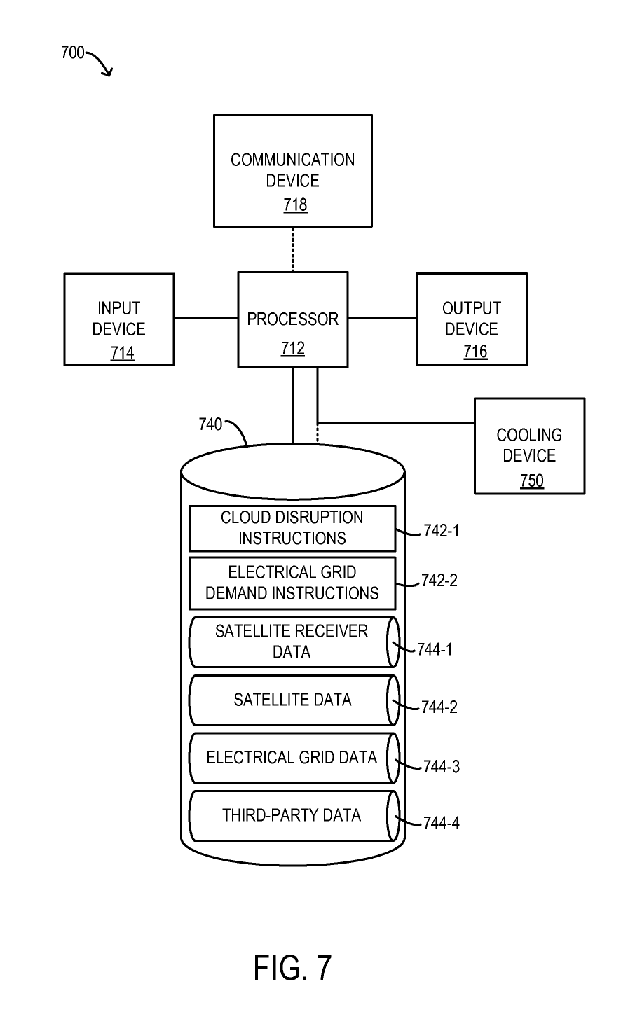

Turning to FIG. 7, a block diagram of an apparatus 700 according to some embodiments is shown. In some embodiments, the apparatus 700 may be similar in configuration and/or functionality to the satellite dishes 122a-n, 222, 422, the set-top boxes 124a-n, the server 130, and/or the central office 430 of FIG. 1, FIG. 2, and/or FIG. 4 herein. The apparatus 700 may, for example, execute, process, facilitate, and/or otherwise be associated with the method 600 of FIG. 6, and/or may output or provide various interfaces. In some embodiments, the apparatus 700 may comprise an electronic processor 712, an input device 714, an output device 716, a communication device 718, and/or a memory device 740. Fewer or more components 712, 714, 716, 718, 740 and/or various configurations of the components 712, 714, 716, 718, 740 may be included in the apparatus 700 without deviating from the scope of embodiments described herein. In some embodiments, the components 712, 714, 716, 718, 740 of the apparatus 700 may be similar in configuration and/or functionality to similarly named and/or numbered components as described herein.

According to some embodiments, the electronic processor 712 may be or include any type, quantity, and/or configuration of electronic and/or computerized processor that is or becomes known. The electronic processor 712 may comprise, for example, an Intel® IXP 2800 network processor or an Intel® XEON™ Processor coupled with an Intel® E7501 chipset. In some embodiments, the electronic processor 712 may comprise multiple inter-connected processors, microprocessors, and/or micro-engines. According to some embodiments, the electronic processor 712 (and/or the apparatus 700 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 700 comprises a server such as a blade server, necessary power may be supplied via a standard AC outlet, power strip, surge protector, and/or Uninterruptible Power Supply (UPS) device.

In some embodiments, the input device 714 and/or the output device 716 are communicatively coupled to the electronic processor 712 (e.g., via wired and/or wireless connections, traces, and/or pathways) and they may generally comprise any types or configurations of input and output components and/or devices that are or become known, respectively. The input device 714 may comprise, for example, a keyboard that allows an operator of the apparatus 700 to interface with the apparatus 700 (e.g., a utility grid manager or operator, such as to implement and/or interact with embodiments herein to conduct utility grid operations based on satellite signal-based data). The output device 716 may, according to some embodiments, comprise a display screen and/or other practicable output component and/or device. The output device 716 may, for example, provide satellite signal, cloud disruption, and/or power demand or estimation data (e.g., via a website and/or via a computer workstation). According to some embodiments, the input device 714 and/or the output device 716 may comprise and/or be embodied in a single device such as a touch-screen monitor.

In some embodiments, the communication device 718 may comprise any type or configuration of communication device that is or becomes known or practicable. The communication device 718 may, for example, comprise a Network Interface Card (NIC), a telephonic device, a cellular network device, a router, a hub, a modem, and/or a communications port or cable. In some embodiments, the communication device 718 may be coupled to receive satellite signals and/or data descriptive thereof and/or to communicate with and/or instruct one or more power facility and/or utility grid devices in accordance with embodiments described herein. According to some embodiments, the communication device 718 may also or alternatively be coupled to the electronic processor 712. In some embodiments, the communication device 718 may comprise an Infra-red Radiation (IR), Radio Frequency (RF), Bluetooth™, Near-Field Communication (NFC), and/or Wi-Fi® network device coupled to facilitate communications between the electronic processor 712 and one or more other devices (such as a satellite, set-top-box, server, etc.).

The memory device 740 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 740 may, according to some embodiments, store one or more of cloud disruption instructions 742-1 and/or electrical grid demand instructions 742-2. In some embodiments, the cloud disruption instructions 742-1 and/or electrical grid demand instructions 742-2 may be utilized by the electronic processor 712 to provide output information via the output device 716 and/or the communication device 718 (e.g., the providing of the indication of the estimated electrical grid power demand at 606 of the method 600 of FIG. 6).

According to some embodiments, the cloud disruption instructions 742-1 may be operable to cause the electronic processor 712 to access satellite receiver data 744-1, satellite data 744-2, electrical grid data 744-3, and/or third-party data 744-4 (e.g., in accordance with the method 600 of FIG. 6 herein). Satellite receiver data 744-1, satellite data 744-2, electrical grid data 744-3, and/or third-party data 744-4 received via the input device 714 and/or the communication device 718 may, for example, be analyzed, sorted, filtered, decoded, decompressed, ranked, scored, plotted, and/or otherwise processed by the electronic processor 712 in accordance with the cloud disruption instructions 742-1. In some embodiments, satellite receiver data 744-1, satellite data 744-2, electrical grid data 744-3, and/or third-party data 744-4 may be fed by the electronic processor 712 through one or more mathematical and/or statistical formulas, rule sets, policies, and/or models in accordance with the cloud disruption instructions 742-1 to determine cloud disruption data (e.g., the determining at 604 of the method 600 of FIG. 6) and/or electrical grid power demand data (e.g., the providing and/or determining at 606 of the method 600 of FIG. 6) as described herein.

According to some embodiments, the electrical grid demand instructions 742-2 may be operable to cause the electronic processor 712 to access the satellite receiver data 744-1, satellite data 744-2, electrical grid data 744-3, and/or third-party data 744-4 (e.g., in accordance with the method 600 of FIG. 6 herein). Satellite receiver data 744-1, satellite data 744-2, electrical grid data 744-3, and/or third-party data 744-4 received via the input device 714 and/or the communication device 718 may, for example, be analyzed, sorted, filtered, decoded, decompressed, ranked, scored, plotted, and/or otherwise processed by the electronic processor 712 in accordance with the electrical grid demand instructions 742-2. In some embodiments, satellite receiver data 744-1, satellite data 744-2, electrical grid data 744-3, and/or third-party data 744-4 may be fed by the electronic processor 712 through one or more mathematical and/or statistical formulas, rule sets, policies, and/or models in accordance with the electrical grid demand instructions 742-2 to determine electrical grid power demand data (e.g., the providing and/or determining at 606 of the method 600 of FIG. 6) and/or to send instructions to and/or otherwise cause a power facility to operate based on electrical demand as described herein.

In some embodiments, the satellite receiver data 744-1 may comprise data including, but not limited to, data descriptive of one or more satellite receivers (e.g., a set-top box), such as model numbers, serial numbers, customer identifiers (e.g., account identifiers), status data, location data, and/or setting data (e.g., AGC setting). According to some embodiments, the satellite data 744-2 may comprise data including, but not limited to, data descriptive of one or more satellites such as azimuth angle, gross signal strength, altitude, and/or observed or inferred signal strength at one or more terrestrial locations. In some embodiments, the electrical grid data 744-3 may comprise data including, but not limited to, data descriptive of electrical input or output capacity, electrical demand data (e.g., current, historic, predicted), data descriptive of locations and/or capacities of generation facilities (such as distributed generation facilities), and/or data descriptive of various electrical grid components such as switches, transformers, etc. According to some embodiments, the third-party data 744-4 may comprise data including, but not limited to, data descriptive of geographic relationships (e.g., between electrical grid components and/or satellite receiver devices), mathematical and/or logical relationships (e.g., between metrics such as AGC levels, cloud disruption levels, and/or power supply levels), weather and/or atmospheric data, radar data, etc.

In some embodiments, the apparatus 700 may comprise a cooling device 750. According to some embodiments, the cooling device 750 may be coupled (physically, thermally, and/or electrically) to the electronic processor 712 and/or to the memory device 740. The cooling device 750 may, for example, comprise a fan, heat sink, heat pipe, radiator, cold plate, and/or other cooling component or device or combinations thereof, configured to remove heat from portions or components of the apparatus 700.

According to some embodiments, the apparatus 700 may generally function as a computer terminal and/or server of a utility company (and/or government entity or third-party service provider), for example, which is utilized to process satellite signal data from remote receivers to determine expected effects on power grid functionality. In some embodiments, the apparatus 700 may comprise a web server and/or other portal (e.g., an Interactive Voice Response Unit (IVRU)) that provides satellite signal and/or utility grid information to customers and/or third-parties. According to some embodiments, the apparatus 700 may comprise and/or provide an interface via which users may visualize, model, and/or otherwise manage satellite signal-based electrical output data and/or utility grid functionality.

Any or all of the exemplary instructions and data types described herein and other practicable types of data may be stored in any number, type, and/or configuration of memory devices that are or become known. The memory device 740 may, for example, comprise one or more data tables or files, databases, table spaces, registers, and/or other storage structures. In some embodiments, multiple databases and/or storage structures (and/or multiple memory devices 740) may be utilized to store information associated with the apparatus 700. According to some embodiments, the memory device 740 may be incorporated into and/or otherwise coupled to the apparatus 700 (e.g., as shown) or may simply be accessible to the apparatus 700 (e.g., externally located and/or situated). In some embodiments, fewer or more data elements 744-1, 744-2, 744-3, 744-4 and/or types than those depicted may be necessary and/or desired to implement embodiments described herein.

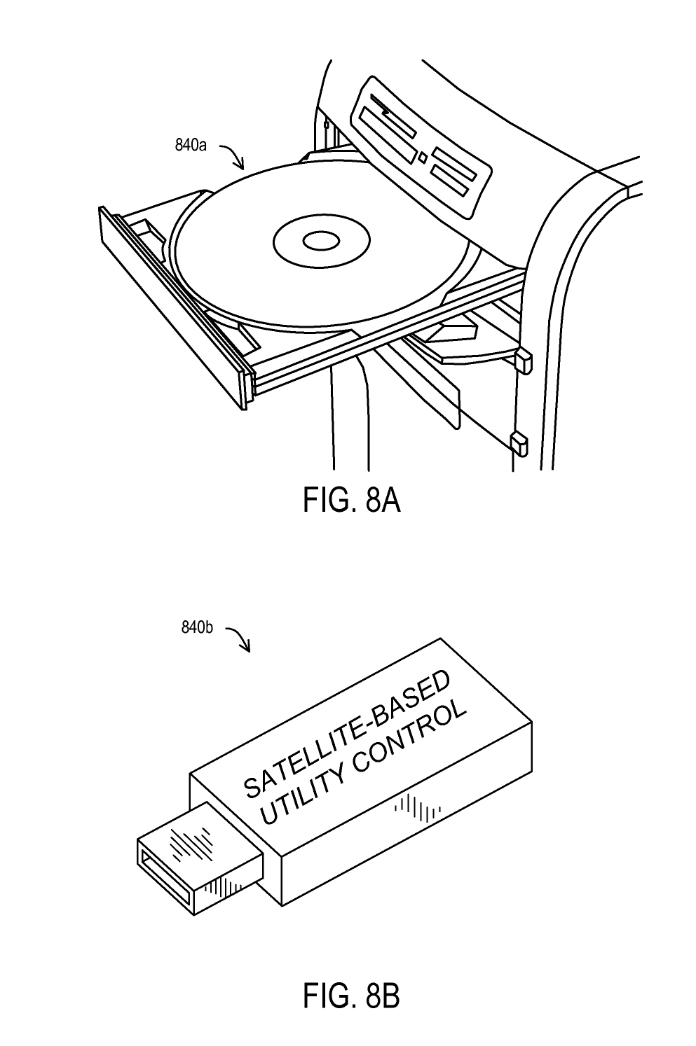

Referring now to FIG. 8A and FIG. 8B, perspective diagrams of exemplary data storage devices 840a-b according to some embodiments are shown. The data storage devices 840a-b may, for example, be utilized to store instructions and/or data such as the satellite receiver data 744-1, satellite data 744-2, electrical grid data 744-3, and/or third-party data 744-4, each of which is described in reference to FIG. 7 herein. In some embodiments, instructions stored on the data storage devices 840a-b may, when executed by a processor (such as the electronic processor 712 of FIG. 7), cause the implementation of and/or facilitate the method 600 of FIG. 6 (and/or portions thereof), described herein.

According to some embodiments, the first data storage device 840a may comprise a CD, CD-ROM, DVD, Blu-Ray™ Disc, and/or other type of optically-encoded disk and/or other computer-readable storage medium that is or becomes know or practicable. In some embodiments, the second data storage device 840b may comprise a USB keyfob, dongle, and/or other type of flash memory data storage device that is or becomes know or practicable. The data storage devices 840a-b may generally store program instructions, code, and/or modules that, when executed by an electronic and/or computerized processing device cause a particular machine to function in accordance with embodiments described herein. In some embodiments, the data storage devices 840a-b depicted in FIG. 8A and FIG. 8B are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. The right is hereby expressly reserved to file additional applications to pursue patents for subject matter that has been disclosed and enabled but not claimed in the present application.

What is claimed is:

1. A method, comprising:
receiving, by a central controller device and from a remote satellite signal receiver device, information descriptive of a signal strength of a satellite signal sent to the remote satellite signal receiver device;
determining, by the central controller device and based on the information, an estimated magnitude of cloud disruption in an area associated with the remote satellite signal receiver device; and
providing, by the central controller device and based on the estimated magnitude of cloud disruption in the area associated with the remote satellite signal receiver device, an indication of an estimated amount of electrical grid power demand.

2. The method of claim 1, wherein the indication of the estimated amount of electrical grid power demand comprises the estimated magnitude of cloud disruption in the area associated with the remote satellite signal receiver device.

3. The method of claim 1, further comprising:
determining, by the central controller device and based on the estimated magnitude of cloud disruption in the area associated with the remote satellite signal receiver device, the estimated amount of electrical grid power demand.

4. The method of claim 3, wherein the determining of the estimated amount of electrical grid power demand, comprises:
determining a capacity of available photovoltaic power in the area associated with the remote satellite signal receiver device;
determining, based on the estimated magnitude of cloud disruption in the area associated with the remote satellite signal receiver device, an estimated magnitude of disruption to the photovoltaic power capacity; and
determining the estimated amount of electrical grid power demand based on the estimated magnitude of disruption to the photovoltaic power capacity.

5. The method of claim 1, wherein the electrical grid supplies electrical power to the area associated with the remote satellite signal receiver device.

6. The method of claim 1, wherein the area associated with the remote satellite signal receiver device comprises an area in which the remote satellite signal receiver device resides.

7. The method of claim 1, wherein the area associated with the remote satellite signal receiver device comprises an area with a pre-defined geographic relationship to a location where the remote satellite signal receiver resides.

8. The method of claim 7, wherein the pre-defined geographic relationship comprises the area being situated downwind of the location where the remote satellite signal receiver resides.

9. The method of claim 7, further comprising:
determining, by the central controller device and based on the estimated magnitude of cloud disruption in the area associated with the remote satellite signal receiver device, the estimated amount of electrical grid power demand.

10. The method of claim 9, wherein the determining of the estimated amount of electrical grid power demand, comprises:
determining a capacity of available photovoltaic power in the area associated with the remote satellite signal receiver device;
determining, based on the estimated magnitude of cloud disruption in the area associated with the remote satellite signal receiver device, an estimated magnitude of disruption to the photovoltaic power capacity; and
determining the estimated amount of electrical grid power demand based on the estimated magnitude of disruption to the photovoltaic power capacity.

11. The method of claim 1, wherein the indication of the estimated amount of electrical grid power demand is provided to an electrical power facility.

12. The method of claim 1, wherein the providing comprises:
transmitting a signal operable to cause an electrical power facility to change a magnitude of electrical output from the electrical power facility.

13. The method of claim 1, wherein the remote satellite signal receiver device comprises a set-top box.

14. The method of claim 1, wherein the information descriptive of the signal strength of the satellite signal sent to the remote satellite signal receiver device comprises an indication of an Automatic Gain Control (AGC) level of the remote satellite signal receiver device.

15. A non-transitory computer-readable medium storing specially-programmed instructions that when executed by an electric processing device, result in:
receiving information descriptive of a signal strength of a satellite signal sent to a remote satellite signal receiver device;
determining, based on the information, an estimated magnitude of cloud disruption in an area associated with the remote satellite signal receiver device; and
providing, based on the estimated magnitude of cloud disruption in the area associated with the remote satellite signal receiver device, an indication of an estimated amount of electrical grid power demand.

16. The non-transitory computer-readable medium of claim 15, wherein the specially-programmed instructions, when executed by the electric processing device, further result in:
determining, based on the estimated magnitude of cloud disruption in the area associated with the remote satellite signal receiver device, the estimated amount of electrical grid power demand.

17. The non-transitory computer-readable medium of claim 16, wherein the specially-programmed instructions, when executed by the electric processing device, further result in:
determining a capacity of available photovoltaic power in the area associated with the remote satellite signal receiver device;
determining, based on the estimated magnitude of cloud disruption in the area associated with the remote satellite signal receiver device, an estimated magnitude of disruption to the photovoltaic power capacity; and
determining the estimated amount of electrical grid power demand based on the estimated magnitude of disruption to the photovoltaic power capacity.

18. An apparatus, comprising:
a computerized processing device; and
a memory device in communication with the computerized processing device and storing specially-programmed instructions that when executed by the computerized processing device result in:
receiving information descriptive of a signal strength of a satellite signal sent to a remote satellite signal receiver device;
determining, based on the information, an estimated magnitude of cloud disruption in an area associated with the remote satellite signal receiver device; and
providing, based on the estimated magnitude of cloud disruption in the area associated with the remote satellite signal receiver device, an indication of an estimated amount of electrical grid power demand.

19. The apparatus of claim 18, further comprising:
a cooling device coupled to cool at least one of the computerized processing device and the memory device.

20. The apparatus of claim 18, wherein the apparatus comprises a set-top box.
